(19) United States
(12) Patent Application Publication
(10) Pub. No.: US 2026/0291818 A1
(43) Pub. Date: Sep. 24, 2026

(54) SYSTEMS AND METHODS FOR ENHANCING LAWFUL INTERCEPTION WITH MACHINE LEARNING ANALYTICS

(71) Applicant: Verizon Patent and Licensing Inc., Basking Ridge, NJ (US)

(72) Inventors: Suzann HUA, Beverly Hills, CA (US); Helen Osias EGLIP, Sammamish, WA (US); Riyaj Uddin AHMED, Coppell, TX (US); Jerry STEBEN, Fort Worth, TX (US)

(73) Assignee: Verizon Patent and Licensing Inc., Basking Ridge, NJ (US)

(21) Appl. No.: 19/083,691

(22) Filed: Mar. 19, 2025

(51) Int. Cl. H04L 41/14; H04L 41/16; H04W 12/80

(52) U.S. Cl. CPC H04L 41/14; H04L 41/16; H04W 12/80

(57) ABSTRACT

A device may provide, to a network device, an indication that the device is capable of processing network data analytics function (NWDAF) analytics data associated with a user equipment (UE), and may receive, from the network device, the NWDAF analytics data based on the indication. The device may store the NWDAF analytics data, and may receive, from a law enforcement agency (LEA), a lawful interception request for the UE. The device may receive interception data for the UE based on the lawful interception request, and may provide the interception data and the NWDAF analytics data to the LEA based on the lawful interception request.

### BACKGROUND

Lawful interception (LI) allows a law enforcement agency (LEA) to monitor the communications of individuals for legal purposes.

### BRIEF DESCRIPTION OF THE DRAWINGS

FIGS. 1A-1E are diagrams of an example associated with enhancing lawful interception with machine learning analytics.

FIG. 2 is a diagram of an example environment in which systems and/or methods described herein may be implemented.

FIG. 3 is a diagram of example components of one or more devices of FIG. 2.

FIG. 4 is a flowchart of an example process for enhancing lawful interception with machine learning analytics.

### DETAILED DESCRIPTION OF EXAMPLE EMBODIMENTS

The following detailed description of example implementations refers to the accompanying drawings. The same reference numbers in different drawings may identify the same or similar elements.

The 3rd Generation Partnership Project (3GPP) has established standards for LI, which include the interception of user equipment (UE) registration connections at an access and mobility management function (AMF) and UE session connections at a session management function (SMF). Additionally, the 3GPP has developed the Network Data Analytics Function (NWDAF), which supports machine learning-based analytics for tracking UE mobility and communication patterns. An NWDAF is a component within core architectures of telecommunications networks. An NWDAF may collect, process (e.g., utilizing machine learning models), and analyze data from various network elements to provide actionable insights. However, the 3GPP LI standards for UE registration and session connection interception and the NWDAF machine learning analytics data operate independently even for the same targeted UE. This disjointed approach is inefficient and fails to leverage the full intelligence capabilities that machine learning analytics data can provide in the context of LI. Furthermore, there is no specific 3GPP specification that addresses the integration of NWDAF analytics data to enhance the effectiveness and efficiency of LI.

Thus, current techniques for providing lawful interception consume computing resources (e.g., processing resources, memory resources, communication resources, and/or the like), networking resources, and/or other resources associated with failing to provide NWDAF analytics data to an LEA, requiring additional dedicated interfaces with the NWDAF for provision of NWDAF analytics data, failing to provide the LEA with advanced insights associated with NWDAF analytics data, handling security issues associated with NWDAF analytics data, handing violations of retention policies and privacy standards associated with NWDAF analytics data, and/or the like.

Some implementations described herein enhance lawful interception with machine learning analytics. For example, a device (e.g., an LI system) may provide, to a network device, an indication that the device is capable of processing NWDAF analytics data associated with a UE, and may receive, from the network device, the NWDAF analytics data based on the indication. The device may store the NWDAF analytics data, and may receive, from a law enforcement agency (LEA), a lawful interception request for the UE. The device may receive interception data for the UE based on the lawful interception request, and may provide the interception data and the NWDAF analytics data to the LEA based on the lawful interception request.

In this way, lawful interception may be enhanced with machine learning analytics. For example, the LI system may provide a network device, such as an AMF or an SMF, with an indication that the LI system is capable of processing NWDAF analytics data associated with a UE. The network device may subscribe to the NWDAF analytics data associated with the UE based on the indication, and may provide the NWDAF analytics data to the LI system for storage. Upon receiving an LI request from an LEA, the LI system may receive interception data for the UE, and may provide both the interception data and the NWDAF analytics data to the LEA. In some implementations, the LI system may delete the interception data and NWDAF analytics data after providing the data to the LEA, may ensure data security by encrypting the NWDAF analytics data before storing, and may manage the NWDAF analytics data for a configurable time period.

Thus, the LI system may conserve computing resources, networking resources, and/or other resources that would have otherwise been consumed by failing to provide NWDAF analytics data to an LEA, requiring additional dedicated interfaces with the NWDAF for provision of NWDAF analytics data, failing to provide the LEA with advanced insights associated with NWDAF analytics data, handling security issues associated with NWDAF analytics data, handing violations of retention policies and privacy standards associated with NWDAF analytics data, and/or the like.

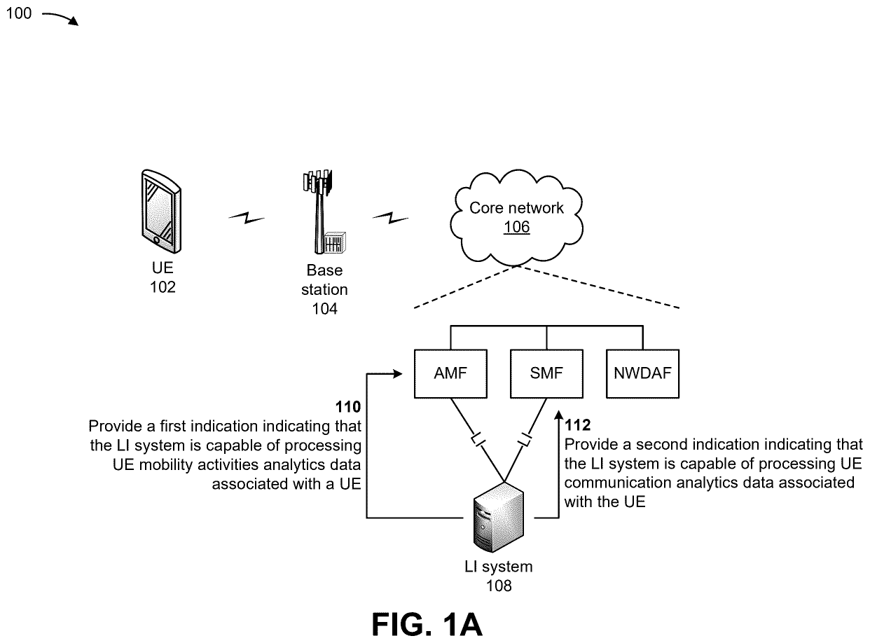

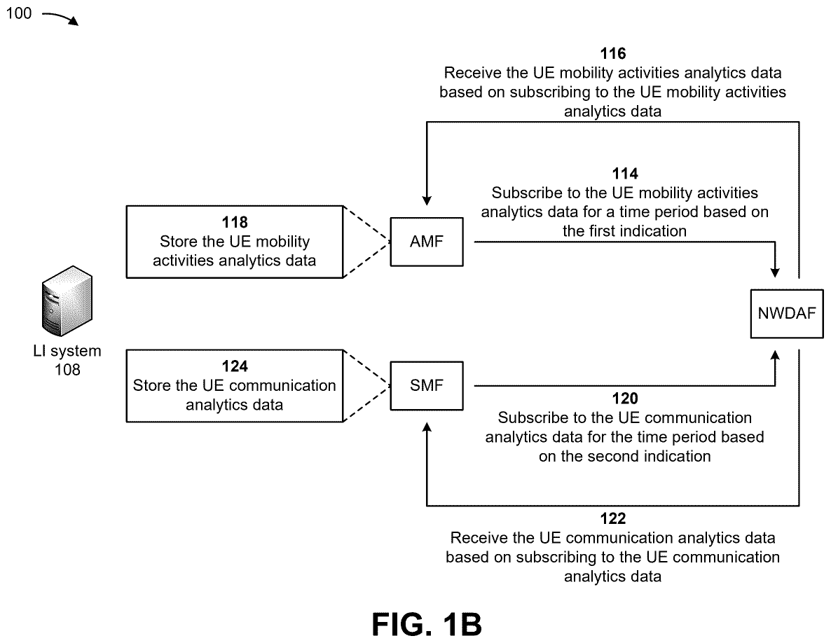

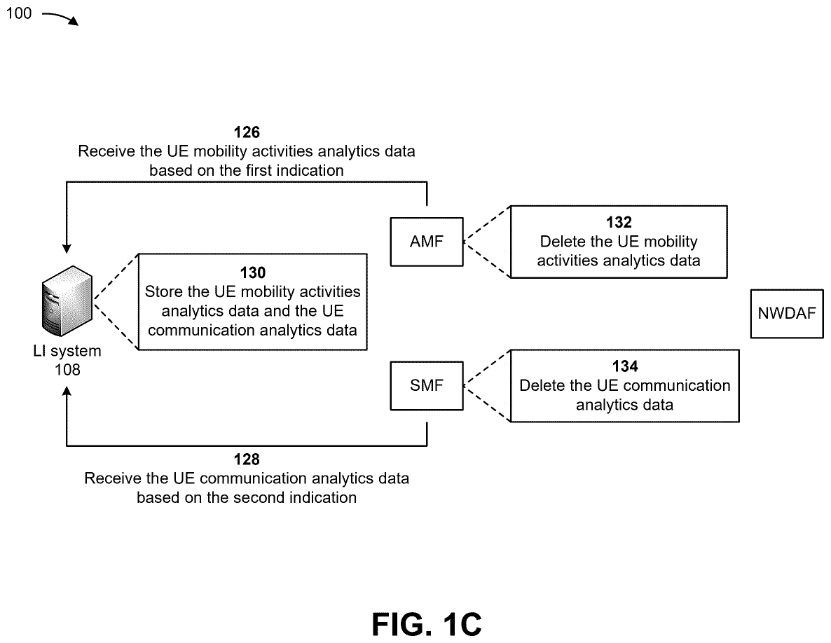

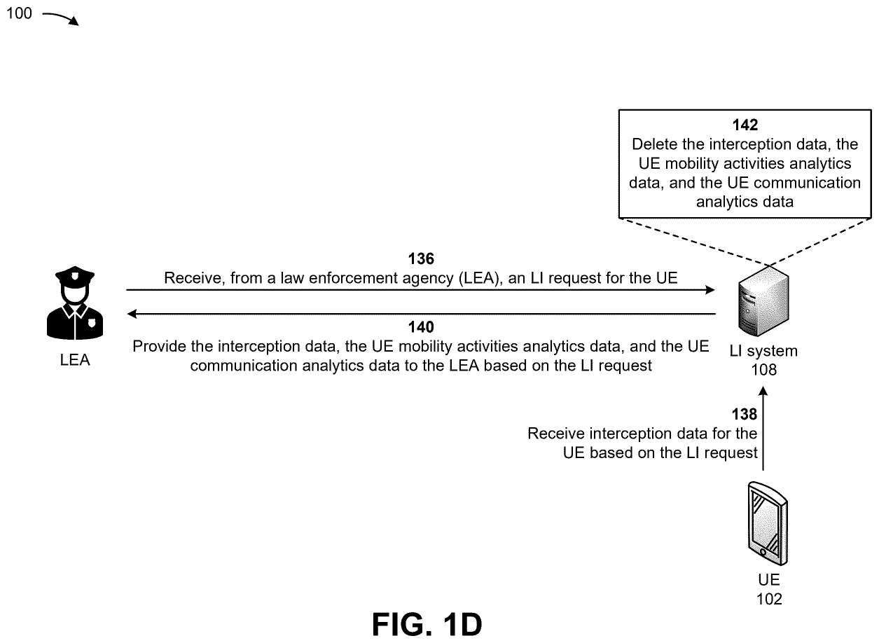

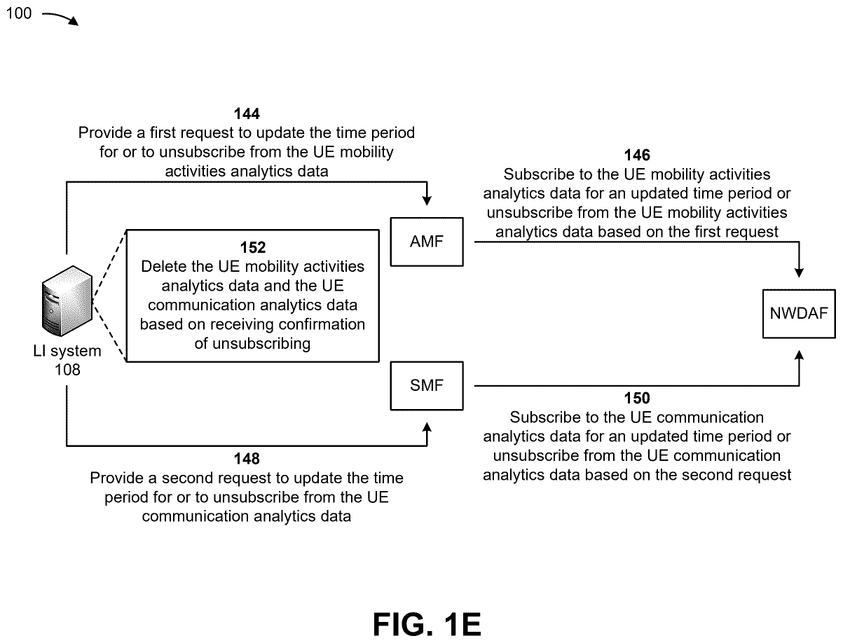

FIGS. 1A-1E are diagrams of an example 100 associated with enhancing lawful interception with machine learning analytics. As shown in FIGS. 1A-1E, example 100 includes a UE 102 associated with a base station 104, a core network 106, and a lawful intercept (LI) system 108. The core network 106 may include an AMF, an SMF, and an NWDAF. Further details of the UE 102, the base station 104, the core network 106, the LI system 108, the AMF, the SMF, and the NWDAF are provided elsewhere herein.

As shown in FIG. 1A, and by reference number 110, the LI system 108 may provide a first indication indicating that the LI system 108 is capable of processing UE mobility activities analytics data. For example, the LI system 108 may establish an interface (e.g., an LI interface) to communicate with the AMF. In some implementations, the LI system 108 may provide, to the AMF and via the interface, the first indication indicating that the LI system 108 is capable of receiving and processing UE mobility activities analytics data related to the UE 102 and generated by the NWDAF. In some implementations, the LI system 108 may determine that the LI system 108 is capable of receiving and processing the UE mobility activities analytics data, and may generate the first indication indicating that the LI system 108 is capable of processing the UE mobility activities analytics data based on determining that the LI system 108 is capable of processing the UE mobility activities analytics data.

The UE mobility activities analytics data may include data derived from tracking and analyzing the movement and connectivity patterns of the UE 102 within a telecommunications network. The UE mobility activities analytics data may provide valuable information about how and where the UE is moving and interacting with the network. In some implementations, the UE mobility activities analytics data may include analytics data identifying locations (e.g., geographical positions) of the UE 102 over time (e.g., which can be derived from base station 104, global positioning system (GPS) data, or other location-tracking methods), handover events of when the UE 102 transitions from one base station 104 to another base station 104 (e.g., indicating movement of the UE 102 across different network coverage areas), measurements of signal strength and quality experienced by the UE 102 at different locations, connection duration indicating how long the UE 102 remains connected to specific base stations 104 (e.g., which can help in understanding user behavior and network utilization), mobility patterns of the UE 102 (e.g., common routes, frequented locations, and times of movement), service usage by the UE 102 (e.g., types of services accessed by the UE 102, such as voice calls, data sessions, and messaging), roaming details about when and where the UE 102 roams into different network areas, traffic load and distribution about how mobility of the UE 102 affects traffic load and distribution across different parts of the network, anomalies and events of the UE 102 (e.g., unusual or unexpected mobility events that may indicate issues such as network problems or abnormal user behavior), and/or the like.

The first indication may enable the AMF to subscribe to the mobility activities analytics data generated by the NWDAF. In some implementations, the first indication may be provided periodically by the LI system 108 to the AMF or may be triggered by a specific event to ensure that the AMF is aware of capabilities of the LI system 108. Additionally, or alternatively, the LI system 108 may provide the first indication to the AMF in real-time to promptly inform the AMF of the capabilities of the LI system 108.

As further shown in FIG. 1A, and by reference number 112, the LI system 108 may provide a second indication indicating that the LI system is capable of processing UE communication analytics data. For example, the LI system 108 may establish an interface (e.g., an LI interface) to communicate with the SMF. In some implementations, the LI system 108 may provide, to the SMF and via the interface, the second indication indicating that the LI system 108 is capable of receiving and processing UE communication analytics data related to the UE 102 and generated by the NWDAF. In some implementations, the LI system 108 may determine that the LI system 108 is capable of receiving and processing the UE communication analytics data, and may generate the second indication indicating that the LI system 108 is capable of processing the UE communication analytics data based on determining that the LI system 108 is capable of processing the UE communication analytics data.

The UE communication analytics data may include data derived from analyzing the communication activities and patterns of the UE 102 within a telecommunications network. The UE communication analytics data may provide valuable information about how the UE 102 interacts with the network and the types of services utilized by the UE 102. In some implementations, the UE communication analytics data may include analytics data identifying call records of the UE 102 (e.g., about voice calls made and received by the UE 102, including call duration, call start and end times, caller and recipient identifiers, and call status), messaging records of the UE 102 (e.g., details about text messages and multimedia messages sent and received by the UE 102, including timestamps, sender and recipient information, and message content), data usage by the UE 102 (e.g., an amount of data transmitted and received, data session durations, and types of data services accessed), application usage by the UE 102 (e.g., including application names, usage frequency, and duration of use), Internet protocol (IP) sessions of the UE 102 (e.g., details about IP-based communication sessions, including source and destination IP addresses, port numbers, session durations, and types of services), quality of service (QoS) metrics for the UE 102 (e.g., the quality of communication services experienced by the UE 102, such as latency, jitter, packet loss, and throughput), network events experienced by the UE 102 (e.g., significant network events related to communication activities, such as session initiations, terminations, and handovers), service access patterns of the UE 102 (e.g., when and how frequently the UE 102 accesses different network services), roaming communication of the UE 102 (e.g., communication activities while the UE 102 is roaming on other networks, including roaming partners, roaming charges, and service usage during roaming), anomalies and security events of the UE 102 (e.g., unusual or suspicious communication activities that may indicate security threats, such as unauthorized access, malware activity, or potential fraud), and/or the like.

The second indication may enable the SMF to subscribe to the UE communication analytics data generated by the NWDAF. In some implementations, the second indication may be provided periodically by the LI system 108 to the SMF or may be triggered by a specific event to ensure that the SMF is aware of capabilities of the LI system 108. Additionally, or alternatively, the LI system 108 may provide the second indication to the SMF in real-time to promptly inform the SMF of the capabilities of the LI system 108.

As shown in FIG. 1B, and by reference number 114, the AMF may subscribe to the UE mobility activities analytics data for a time period based on the first indication. For example, based on receiving the first indication, the AMF may subscribe to the UE mobility activities analytics data for the UE 102 and generated by the NWDAF. The time period of the subscription may be determined based on a configuration or specific requirements indicated by the LI system 108 (e.g., in the first indication). In some implementations, the AMF may request the UE mobility activities analytics data for a time period specified by the LEA for the UE 102. For example, the LEA may provide, to the LI system 108, an indication specifying the time period for which the AMF should request the UE mobility activities analytics data, and the LI system 108 may provide the indication to the AMF. In some implementations, the AMF may generate a subscription request for receiving the UE mobility activities analytics data for the time period, and may provide the request to the NWDAF.

As further shown in FIG. 1B, and by reference number 116, the AMF may receive the UE mobility activities analytics data based on subscribing to the UE mobility activities analytics data. For example, once subscribed, the AMF may receive the UE mobility activities analytics data from the NWDAF for the specified time period. In some implementations, the NWDAF may retrieve data associated with the UE 102 based on the subscription, and may process the data associated with UE 102, with one or more machine learning models, to generate the UE mobility activities analytics data. The NWDAF may provide the UE mobility activities analytics data to the AMF, and the AMF may receive the UE mobility activities analytics data. In some implementations, the AMF may periodically receive the UE mobility activities analytics data from the NWDAF, may continuously receive UE mobility activities analytics data from the NWDAF, and/or the like.

As further shown in FIG. 1B, and by reference number 118, the AMF may store the UE mobility activities analytics data. For example, the AMF may store the UE mobility activities analytics data in a secure data structure (e.g., a database, a table, a list, and/or the like) associated with the AMF. The data structure may be designed to prevent unauthorized access to the UE mobility activities analytics data and ensure data integrity. In some implementations, the AMF may convert the UE mobility activities analytics data into a secure and encrypted format, prior to storing the UE mobility activities analytics data, to ensure data integrity and confidentiality. The stored UE mobility activities analytics data may be utilized for further processing or analysis when required (e.g., for lawful interception purposes).

As further shown in FIG. 1B, and by reference number 120, the SMF may subscribe to the UE communication analytics data for the time period based on the second indication. For example, based on receiving the second indication, the SMF may subscribe to the UE communication analytics data for the UE 102 and generated by the NWDAF. The time period of the subscription may be determined based on a configuration or specific requirements indicated by the LI system 108 (e.g., in the first indication). In some implementations, the SMF may request the UE communication analytics data for a time period specified by the LEA for the UE 102. For example, the LEA may provide, to the LI system 108, an indication specifying the time period for which the SMF should request the UE communication analytics data, and the LI system 108 may provide the indication to the SMF. In some implementations, the SMF may generate a subscription request for receiving the UE communication analytics data for the time period, and may provide the request to the NWDAF.

As further shown in FIG. 1B, and by reference number 122, the SMF may receive the UE communication analytics data based on subscribing to the UE communication analytics data. For example, once subscribed, the SMF may receive the UE communication analytics data from the NWDAF for the specified time period. In some implementations, the NWDAF may retrieve data associated with the UE 102 based on the subscription, and may process the data associated with the UE 102, with one or more machine learning models, to generate the UE communication analytics data. The NWDAF may provide the UE communication analytics data to the SMF, and the SMF may receive the UE communication analytics data. In some implementations, the SMF may periodically receive the UE communication analytics data from the NWDAF, may continuously receive UE communication analytics data from the NWDAF, and/or the like.

As further shown in FIG. 1B, and by reference number 124, the SMF may store the UE communication analytics data. For example, the SMF may store the UE communication analytics data in a secure data structure (e.g., a database, a table, a list, and/or the like) associated with the SMF. The data structure may be designed to prevent unauthorized access to the UE communication analytics data and ensure data integrity. In some implementations, the AMF may convert the UE communication analytics data into a secure and encrypted format, prior to storing the UE communication analytics data, to ensure data integrity and confidentiality. The stored UE communication analytics data may be utilized for further processing or analysis when required (e.g., for lawful interception purposes).

As shown in FIG. 1C, and by reference number 126, the LI system 108 may receive the UE mobility activities analytics data based on the first indication. For example, the LI system 108 may receive the UE mobility activities analytics data from the AMF based on providing the first indication to the AMF. In some implementations, the LI system 108 may obtain UE mobility activities analytics data from the AMF after the AMF subscribes to the UE mobility activities analytics data from the NWDAF. For example, the AMF may subscribe to the UE mobility activities analytics data in response to a request from the LI system 108 and may subsequently provide the UE mobility activities analytics data to the LI system 108.

As further shown in FIG. 1C, and by reference number 128, the LI system 108 may receive the UE communication analytics data based on the second indication. For example, the LI system 108 may receive the UE communication analytics data from the SMF based on providing the second indication to the SMF. In some implementations, the LI system 108 may obtain UE communication analytics data from the SMF after the SMF subscribes to the UE communication analytics data from the NWDAF. For example, the SMF may subscribe to the UE communication analytics data in response to a request from the LI system 108 and may subsequently provide the UE communication analytics data to the LI system 108.

As further shown in FIG. 1C, and by reference number 130, the LI system 108 may store the UE mobility activities analytics data and the UE communication analytics data. For example, the LI system 108 may store the analytics data in a secure and encrypted data structure associated with the LI system 108, ensuring data integrity and confidentiality. The stored UE mobility activities analytics data and/or the stored UE communication analytics data may be utilized for further processing or analysis when required, such as for lawful interception purposes. In some implementations, the LI system 108 may convert the UE mobility activities analytics data and the UE communication analytics data to an encrypted format prior to storing in the data structure. Additionally, or alternatively, the data structure may maintain compliance with data security standards to ensure that storage and handling of the UE mobility activities analytics data and the UE communication analytics data adhere to legal requirements.

As further shown in FIG. 1C, and by reference number 132, the AMF may delete the UE mobility activities analytics data. For example, after providing the UE mobility activities analytics data to the LI system 108, the AMF may delete the UE mobility activities analytics data from the data structure associated with the AMF to ensure compliance with data retention policies and to maintain data security. This may ensure that the UE mobility activities analytics data is not retained longer than necessary, and may minimize potential security risks. Additionally, or alternatively, deleting the UE mobility activities analytics data may enable the AMF to efficiently manage storage resources.

As further shown in FIG. 1C, and by reference number 134, the SMF may delete the UE communication analytics data. For example, after providing the UE communication analytics data to the LI system 108, the SMF may delete the UE communication analytics data from the data structure associated with the SMF to ensure compliance with data retention policies and to maintain data security. This may ensure that the UE communication analytics data is not retained longer than necessary, and may minimize potential security risks. Additionally, or alternatively, deleting the UE communication analytics data may enable the SMF to efficiently manage storage resources.

As shown in FIG. 1D, and by reference number 136, the LI system 108 may receive, from an LEA, an LI request for the UE 102. For example, the LEA may generate an LI request to monitor and intercept communications or activities of the UE 102 as part of a legal investigation. In some implementations, the LI request may specify the types of data or communications to intercept from the UE 102, such as voice calls or text messages, and a time period to intercept the data or communications. The LEA may provide the LI request to the LI system 108, and the LI system 108 may receive the LI request. Additionally, or alternatively, the LI system 108 may process the LI request from an LEA to initiate monitoring of the UE 102. This may include the LI system 108 verifying the LI request and initiating necessary procedures to begin monitoring communications of the UE 102.

As further shown in FIG. 1D, and by reference number 138, the LI system 108 may receive interception data for the UE 102 based on the LI request. For example, based on the LI request, the LI system 108 may communicate with network components to obtain interception data related to activities of the UE 102, such as call records, messaging records, data session logs, and other relevant communication details. This may involve accessing various network logs and databases to retrieve the interception data. In some implementations, the LI system 108 may receive the interception data for the UE 102 during a time period specified in the LI request. In some implementations, the interception data may include timestamps, identifiers of involved parties, content of communications, and other metadata associated with intercepted activities.

As further shown in FIG. 1D, and by reference number 140, the LI system 108 may provide the interception data, the UE mobility activities analytics data, and the UE communication analytics data to the LEA based on the LI request. For example, the LI system 108 may compile a report that includes the requested interception data along with additional analytics data obtained from the NWDAF (e.g., the UE mobility activities analytics data, and the UE communication analytics data). The report may provide the LEA with a comprehensive view of activities and patterns associated with the UE 102. The LI system 108 may provide the report to the LEA, and the LEA may receive the report. In some implementations, the LI system 108 may generate a report based on the interception data, and may include the UE mobility activities analytics data and the UE communication analytics data as an attachment to the report. The LI system 108 may provide the report and the attachment to the LEA, and the LEA may receive the report and the attachment.

As further shown in FIG. 1D, and by reference number 142, the LI system 108 may delete the interception data, the UE mobility activities analytics data, and the UE communication analytics data. For example, the LI system 108 may ensure data security and compliance with data retention policies by deleting the interception data, the UE mobility activities analytics data, and the UE communication analytics data after providing the data to the LEA. This may enable the LI system 108 to minimize potential security risks and manage storage resources efficiently. This may also ensure that sensitive data is not retained longer than necessary, and may enable the LI system 108 to comply with legal and regulatory requirements regarding data retention and deletion.

As shown in FIG. 1E, and by reference number 144, the LI system 108 may provide a first request to update the time period for, or to unsubscribe from, the UE mobility activities analytics data. For example, based on the requirements of the LEA or a change in the monitoring parameters, the LI system 108 may generate a request (e.g., the first request) to either update the subscription time period for the UE mobility activities analytics data or to unsubscribe from receiving further analytics data. The LI system 108 may provide the first request to the AMF, and the AMF may receive the first request. The first request may ensure that the AMF is aligned with the latest monitoring parameters. In some implementations, the LI system 108 may provide, to the AMF, a request to update the time period for receiving the UE mobility activities analytics data associated with the UE 102. For example, if the LEA's requirements change, the LI system 108 may request that the AMF reduce or extend the time period. Additionally, or alternatively, the LI system 108 may provide, to the AMF, a request to unsubscribe from receiving the UE mobility activities analytics data associated with the UE 102. For example, if the LEA no longer wishes to monitor the UE 102, the LI system 108 may request that the AMF unsubscribe from the UE mobility activities analytics data.

As further shown in FIG. 1E, and by reference number 146, the AMF may subscribe to the UE mobility activities analytics data for an updated time period or unsubscribe from the UE mobility activities analytics data based on the first request. For example, upon receiving the first request from the LI system 108, the AMF may adjust the subscription with the NWDAF to either extend or shorten the time period for receiving UE mobility activities analytics data or to completely unsubscribe from receiving UE mobility activities analytics data. In some implementations, the AMF may request to update the time period (e.g., an updated time period) for receiving the UE mobility activities analytics data associated with the UE 102 from the NWDAF. Additionally, or alternatively, the AMF may request to unsubscribe from receiving the UE mobility activities analytics data associated with the UE 102 from the NWDAF. In this way, the AMF may ensure that the subscription for the UE mobility activities analytics data is up-to-date with the monitoring directives.

As further shown in FIG. 1E, and by reference number 148, the LI system 108 may provide a second request to update the time period for, or to unsubscribe from, the UE communication analytics data. For example, based on the requirements of the LEA or a change in the monitoring parameters, the LI system 108 may generate a request (e.g., the second request) to either update the subscription time period for the UE communication analytics data or to unsubscribe from receiving further analytics data. The LI system 108 may provide the second request to the SMF, and the SMF may receive the second request. The second request may ensure that the SMF is aligned with the latest monitoring parameters. In some implementations, the LI system 108 may provide, to the SMF, a request to update the time period for receiving the UE communication analytics data associated with the UE 102. For example, if the LEA's requirements change, the LI system 108 may request that the SMF reduce or extend the time period. Additionally, or alternatively, the LI system 108 may provide, to the SMF, a request to unsubscribe from receiving the UE communication analytics data associated with the UE 102. For example, if the LEA no longer wishes to monitor the UE 102, the LI system 108 may request that the SMF unsubscribe from the UE communication analytics data.

As further shown in FIG. 1E, and by reference number 150, the SMF may subscribe to the UE communication analytics data for an updated time period or unsubscribe from the UE communication analytics data based on the second request. For example, upon receiving the second request from the LI system 108, the SMF may adjust the subscription with the NWDAF to either extend or shorten the time period for receiving UE communication analytics data or to completely unsubscribe from receiving UE communication analytics data. In some implementations, the SMF may request to update the time period (e.g., an updated time period) for receiving the UE communication analytics data associated with the UE 102 from the NWDAF. Additionally, or alternatively, the SMF may request to unsubscribe from receiving the UE communication analytics data associated with the UE 102 from the NWDAF. In this way, the SMF may ensure that the subscription for the UE communication analytics data is up-to-date with the monitoring directives.

As further shown in FIG. 1E, and by reference number 152, the LI system 108 may delete the UE mobility activities analytics data and the UE communication analytics data based on receiving confirmation of unsubscribing from the UE mobility activities analytics data and the UE communication analytics data. For example, after receiving confirmation from the AMF and/or the SMF that the subscriptions for the UE mobility activities analytics data and/or the UE communication analytics data have been terminated, the LI system 108 may delete the UE mobility activities analytics data and the UE communication analytics data from storage. This may enable the LI system 108 to minimize potential security risks and manage storage resources efficiently. This may also ensure that sensitive data is not retained longer than necessary, and may enable the LI system 108 to comply with legal and regulatory requirements regarding data retention and deletion.

In this way, lawful interception may be enhanced with machine learning analytics. For example, the LI system may provide a network device, such as an AMF or an SMF, with an indication that the LI system is capable of processing NWDAF analytics data associated with a UE. The network device may subscribe to the NWDAF analytics data associated with the UE based on the indication, and may provide the NWDAF analytics data to the LI system for storage. Upon receiving an LI request from an LEA, the LI system may receive interception data for the UE, and may provide both the interception data and the NWDAF analytics data to the LEA. In some implementations, the LI system may delete the interception data and NWDAF analytics data after providing the data to the LEA, may ensure data security by encrypting the NWDAF analytics data before storing, and may manage the NWDAF analytics data for a configurable time period.

Thus, the LI system may conserve computing resources, networking resources, and/or other resources that would have otherwise been consumed by failing to provide NWDAF analytics data to an LEA, requiring additional dedicated interfaces with the NWDAF for provision of NWDAF analytics data, failing to provide the LEA with advanced insights associated with NWDAF analytics data, handling security issues associated with NWDAF analytics data, handing violations of retention policies and privacy standards associated with NWDAF analytics data, and/or the like.

As indicated above, FIGS. 1A-1E are provided as an example. Other examples may differ from what is described with regard to FIGS. 1A-1E. The number and arrangement of devices shown in FIGS. 1A-1E are provided as an example. In practice, there may be additional devices, fewer devices, different devices, or differently arranged devices than those shown in FIGS. 1A-1E. Furthermore, two or more devices shown in FIGS. 1A-1E may be implemented within a single device, or a single device shown in FIGS. 1A-1E may be implemented as multiple, distributed devices. Additionally, or alternatively, a set of devices (e.g., one or more devices) shown in FIGS. 1A-1E may perform one or more functions described as being performed by another set of devices shown in FIGS. 1A-1E.

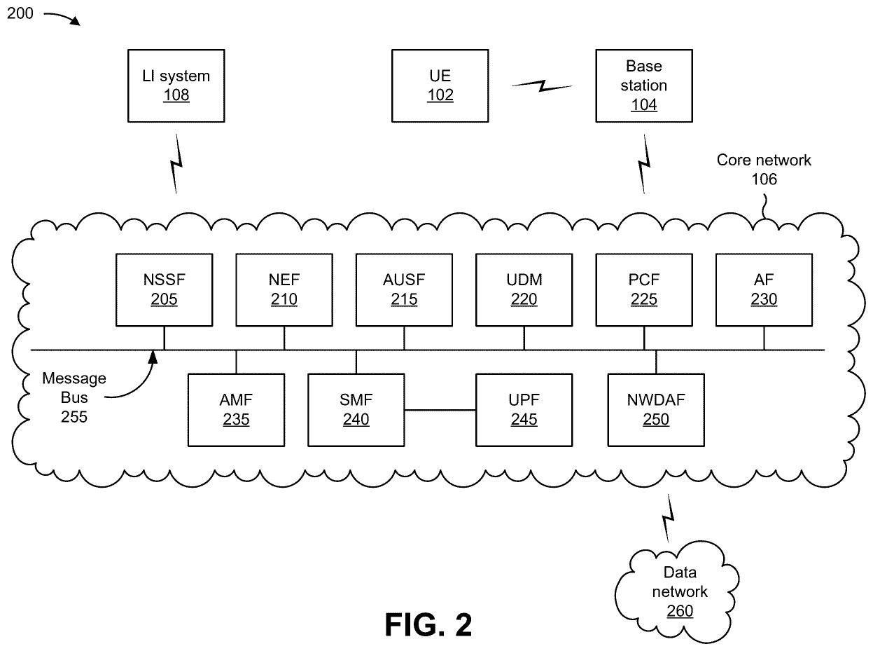

FIG. 2 is a diagram of an example environment 200 in which systems and/or methods described herein may be implemented. As shown in FIG. 2, the example environment 200 may include the UE 102, a base station 104, the core network 106, the LI system 108, and a data network 260. Devices and/or networks of the example environment 200 may interconnect via wired connections, wireless connections, or a combination of wired and wireless connections.

The UE 102 includes one or more devices capable of receiving, generating, storing, processing, and/or providing information, such as information described herein. For example, the UE 102 may include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The base station 104 may support, for example, a cellular radio access technology (RAT). The base station 104 may include one or more base stations (e.g., base transceiver stations, radio base stations, node Bs, eNodeBs (eNBs) (e.g., the 4G base station 104), gNodeBs (gNBs) (e.g., the 5G base stations 104-1 and 104-2), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the UE 102. The base station 104 may transfer traffic between the UE 102 (e.g., using a cellular RAT), one or more base stations (e.g., using a wireless interface or a backhaul interface, such as a wired backhaul interface), and/or the core network 106. The base station 104 may provide one or more cells that cover geographic areas.

In some implementations, the base station 104 may perform scheduling and/or resource management for the UE 102 covered by the base station 104 (e.g., the UE 102 covered by a cell provided by the base station 104). In some implementations, the base station 104 may be controlled or coordinated by a network controller, which may perform load balancing, network-level configuration, and/or other operations. The network controller may communicate with the base station 104 via a wireless or wireline backhaul. In some implementations, the base station 104 may include a network controller, a self-organizing network (SON) module or component, or a similar module or component. In other words, the base station 104 may perform network control, scheduling, and/or network management functions (e.g., for uplink, downlink, and/or sidelink communications of the UE 102 covered by the base station 104).

The LI system 108 may include one or more devices capable of receiving, generating, storing, processing, providing, and/or routing information, as described elsewhere herein. The LI system 108 may include a communication device and/or a computing device. For example, the LI system 108 may include a server, such as an application server, a client server, a web server, a database server, a host server, a proxy server, a virtual server (e.g., executing on computing hardware), or a server in a cloud computing system. In some implementations, the LI system 108 may include computing hardware used in a cloud computing environment, such as one or more serverless components (e.g., one or more serverless functions).

In some implementations, the core network 106 may include an example functional architecture in which systems and/or methods described herein may be implemented. For example, the core network 106 may include an example architecture of a fifth generation (5G) next generation (NG) core network included in a 5G wireless telecommunications system. While the example architecture of the core network 106 shown in FIG. 2 may be an example of a service-based architecture, in some implementations, the core network 106 may be implemented as a reference-point architecture and/or a 4G core network, among other examples.

As shown in FIG. 2, the core network 106 may include a number of functional elements. The functional elements may include, for example, a network slice selection function (NSSF) 205, a network exposure function (NEF) 210, an authentication server function (AUSF) 215, a unified data management (UDM) component 220, a policy control function (PCF) 225, an application function (AF) 230, an AMF 235, an SMF 240, a user plane function (UPF) 245, and/or an NWDAF 250. These functional elements may be communicatively connected via a message bus 255. Each of the functional elements shown in FIG. 2 is implemented on one or more devices associated with a wireless telecommunications system. In some implementations, one or more of the functional elements may be implemented on physical devices, such as an access point, a base station, and/or a gateway. In some implementations, one or more of the functional elements may be implemented on a computing device of a cloud computing environment.

The NSSF 205 includes one or more devices that select network slice instances for the UE 102. By providing network slicing, the NSSF 205 allows an operator to deploy multiple substantially independent end-to-end networks potentially with the same infrastructure. In some implementations, each slice may be customized for different services.

The NEF 210 includes one or more devices that support exposure of capabilities and/or events in the wireless telecommunications system to help other entities in the wireless telecommunications system discover network services.

The AUSF 215 includes one or more devices that act as an authentication server and support the process of authenticating the UE 102 in the wireless telecommunications system.

The UDM 220 includes one or more devices that store user data and profiles in the wireless telecommunications system. The UDM 220 may be used for fixed access and/or mobile access in the core network 106.

The PCF 225 includes one or more devices that provide a policy framework that incorporates network slicing, roaming, packet processing, and/or mobility management, among other examples.

The AF 230 includes one or more devices that support application influence on traffic routing, access to the NEF 210, and/or policy control, among other examples.

The AMF 235 includes one or more devices that act as a termination point for non-access stratum (NAS) signaling and/or mobility management, among other examples.

The SMF 240 includes one or more devices that support the establishment, modification, and release of communication sessions in the wireless telecommunications system. For example, the SMF 240 may configure traffic steering policies at the UPF 245 and/or may enforce user equipment Internet protocol (IP) address allocation and policies, among other examples.

The UPF 245 includes one or more devices that serve as an anchor point for intraRAT and/or interRAT mobility. The UPF 245 may apply rules to packets, such as rules pertaining to packet routing, traffic reporting, and/or handling user plane quality of service (QoS), among other examples.

The NWDAF 250 includes one or more devices that enable advanced data analytics within the core network 106. The NWDAF 250 collects, processes, and analyzes data from various network elements to provide valuable insights that can help improve the efficiency, performance, and management of the core network 106. The NWDAF 250 may gather data from multiple sources within the core network 106, such as the AMF 235, the SMF 240, the UPF 245, and/or the like. The NWDAF 250 may utilize and other analytical tools with the collected data to identify trends, detect anomalies, and predict future network conditions. The NWDAF 250 may provide reports and analytics outputs to various network entities, such as the PCF 225, the AF 230, an operations and management (OAM) system, and/or the like.

The message bus 255 represents a communication structure for communication among the functional elements. In other words, the message bus 255 may permit communication between two or more functional elements.

The data network 260 includes one or more wired and/or wireless data networks. For example, the data network 260 may include an IP Multimedia Subsystem (IMS), a public land mobile network (PLMN), a local area network (LAN), a wide area network (WAN), a metropolitan area network (MAN), a private network such as a corporate intranet, an ad hoc network, the Internet, a fiber optic-based network, a cloud computing network, a third party services network, an operator services network, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the example environment 200 may perform one or more functions described as being performed by another set of devices of the example environment 200.

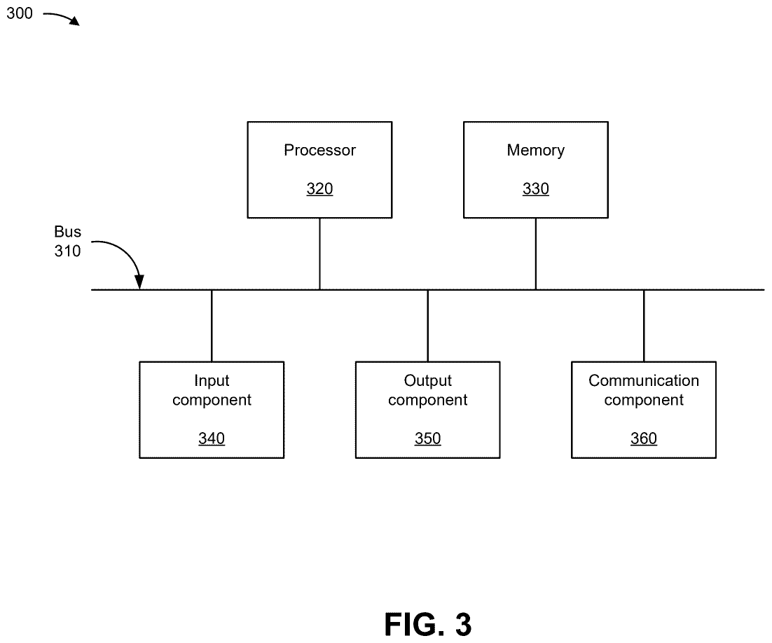

FIG. 3 is a diagram of example components of a device 300, which may correspond to the UE 102, the base station 104, the LI system 108, the NSSF 205, the NEF 210, the AUSF 215, the UDM 220, the PCF 225, the AF 230, the AMF 235, the SMF 240, the UPF 245, and/or the NWDAF 250. In some implementations, the UE 102, the base station 104, the LI system 108, the NSSF 205, the NEF 210, the AUSF 215, the UDM 220, the PCF 225, the AF 230, the AMF 235, the SMF 240, the UPF 245, and/or the NWDAF 250 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

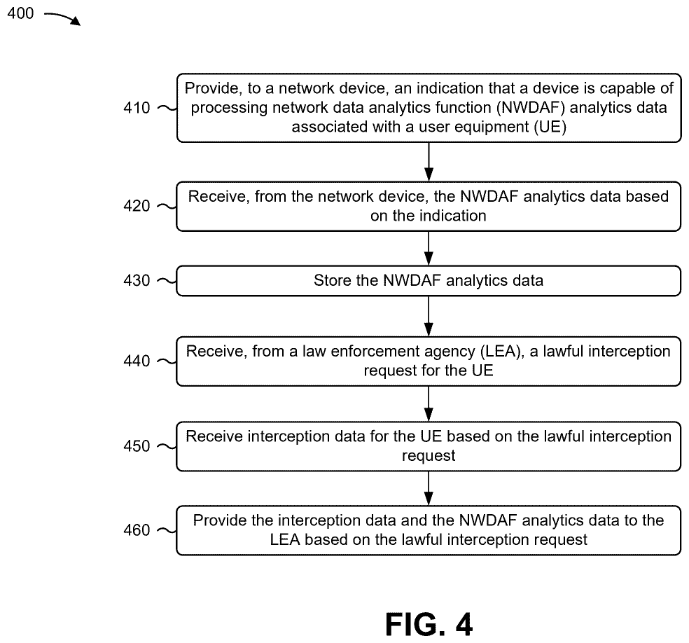

FIG. 4 is a flowchart of an example process 400 for enhancing lawful interception with machine learning analytics. In some implementations, one or more process blocks of FIG. 4 may be performed by a device (e.g., the LI system 108). In some implementations, one or more process blocks of FIG. 4 may be performed by another device or a group of devices separate from or including the device, such as a network device (e.g., the AMF 235, the SMF 240, the NWDAF 250, and/or the like) of the core network 106. Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include providing, to a network device, an indication that the device is capable of processing NWDAF analytics data associated with a UE (block 410). For example, the device may provide, to a network device, an indication that the device is capable of processing NWDAF analytics data associated with a UE, as described above. In some implementations, the network device is one of an AMF or an SMF.

As further shown in FIG. 4, process 400 may include receiving, from the network device, the NWDAF analytics data based on the indication (block 420). For example, the device may receive, from the network device, the NWDAF analytics data based on the indication, as described above. In some implementations, receiving the NWDAF analytics data based on the indication includes one or more of receiving, based on the indication, UE mobility activities analytics data associated with the UE; or receiving, based on the indication, UE communication analytics data associated with the UE. In some implementations, receiving the NWDAF analytics data based on the indication includes receiving the NWDAF analytics data for a configurable time period.

As further shown in FIG. 4, process 400 may include storing the NWDAF analytics data (block 430). For example, the device may store the NWDAF analytics data, as described above.

As further shown in FIG. 4, process 400 may include receiving, from an LEA, a lawful interception request for the UE (block 440). For example, the device may receive, from an LEA, a lawful interception request for the UE, as described above.

As further shown in FIG. 4, process 400 may include receiving interception data for the UE based on the lawful interception request (block 450). For example, the device may receive interception data for the UE based on the lawful interception request, as described above.

As further shown in FIG. 4, process 400 may include providing the interception data and the NWDAF analytics data to the LEA based on the lawful interception request (block 460). For example, the device may provide the interception data and the NWDAF analytics data to the LEA based on the lawful interception request, as described above. In some implementations, providing the interception data and the NWDAF analytics data to the LEA includes generating a report based on the interception data, including the NWDAF analytics data as an attachment to the report, and providing the report and the attachment to the LEA.

In some implementations, process 400 includes deleting the interception data and the NWDAF analytics data after providing the interception data and the NWDAF analytics data to the LEA. In some implementations, process 400 includes determining that the device is capable of processing the NWDAF analytics data, and generating the indication that the device is capable of processing the NWDAF analytics data based on determining that the device is capable of processing the NWDAF analytics data.

In some implementations, process 400 includes providing, to the network device, a request to update the configurable time period for NWDAF analytics data. In some implementations, process 400 includes encrypting the NWDAF analytics data prior to storing the NWDAF analytics data. In some implementations, process 400 includes receiving, from the LEA, a removal request to remove the UE from lawful interception, and providing, to the network device, a request to unsubscribe from the NWDAF analytics associated with the UE based on the removal request.

In some implementations, process 400 includes receiving, from the network device, a confirmation of unsubscribing from the NWDAF analytics associated with the UE, and deleting the NWDAF analytics data after receiving the confirmation. In some implementations, process 400 includes determining that the device is capable of processing UE mobility activities analytics data, and generating the indication that the device is capable of processing the NWDAF analytics data based on determining that the device is capable of processing the UE mobility activities analytics data. In some implementations, process 400 includes determining that the device is capable of processing UE communication analytics data, and generating the indication that the device is capable of processing the NWDAF analytics data based on determining that the device is capable of processing the UE communication analytics data.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
providing, by a device and to a network device, an indication that the device is capable of processing network data analytics function (NWDAF) analytics data associated with a user equipment (UE);
receiving, by the device and from the network device, the NWDAF analytics data based on the indication;
storing, by the device, the NWDAF analytics data;
receiving, by the device and from a law enforcement agency (LEA), a lawful interception request for the UE;
receiving, by the device, interception data for the UE based on the lawful interception request; and
providing, by the device, the interception data and the NWDAF analytics data to the LEA based on the lawful interception request.

2. The method of claim 1, further comprising:
deleting the interception data and the NWDAF analytics data after providing the interception data and the NWDAF analytics data to the LEA.

3. The method of claim 1, further comprising:
determining that the device is capable of processing the NWDAF analytics data; and
generating the indication that the device is capable of processing the NWDAF analytics data based on determining that the device is capable of processing the NWDAF analytics data.

4. The method of claim 1, wherein receiving the NWDAF analytics data based on the indication comprises one or more of:
receiving, based on the indication, UE mobility activities analytics data associated with the UE; or
receiving, based on the indication, UE communication analytics data associated with the UE.

5. The method of claim 1, wherein receiving the NWDAF analytics data based on the indication comprises:
receiving the NWDAF analytics data for a configurable time period.

6. The method of claim 5, further comprising:
providing, to the network device, a request to update the configurable time period for NWDAF analytics data.

7. The method of claim 1, further comprising:
encrypting the NWDAF analytics data prior to storing the NWDAF analytics data.

8. A device, comprising:
one or more processors configured to:
provide, to a network device, an indication that the device is capable of processing network data analytics function (NWDAF) analytics data associated with a user equipment (UE);
receive, from the network device, the NWDAF analytics data based on the indication;
encrypt the NWDAF analytics data;
store the NWDAF analytics data;
receive, from a law enforcement agency (LEA), a lawful interception request for the UE;
receive interception data for the UE based on the lawful interception request; and
provide the interception data and the NWDAF analytics data to the LEA based on the lawful interception request.

9. The device of claim 8, wherein the network device is one of an access and mobility management function or a session management function.

10. The device of claim 8, wherein the one or more processors, to provide the interception data and the NWDAF analytics data to the LEA, are configured to:
generate a report based on the interception data;
include the NWDAF analytics data as an attachment to the report; and
provide the report and the attachment to the LEA.

11. The device of claim 8, wherein the one or more processors are further configured to:
receive, from the LEA, a removal request to remove the UE from lawful interception; and
provide, to the network device, a request to unsubscribe from the NWDAF analytics associated with the UE based on the removal request.

12. The device of claim 11, wherein the one or more processors are further configured to:
receive, from the network device, a confirmation of unsubscribing from the NWDAF analytics associated with the UE; and
delete the NWDAF analytics data after receiving the confirmation.

13. The device of claim 8, wherein the one or more processors are further configured to:
determine that the device is capable of processing UE mobility activities analytics data; and
generate the indication that the device is capable of processing the NWDAF analytics data based on determining that the device is capable of processing the UE mobility activities analytics data.

14. The device of claim 8, wherein the one or more processors are further configured to:
determine that the device is capable of processing UE communication analytics data; and
generate the indication that the device is capable of processing the NWDAF analytics data based on determining that the device is capable of processing the UE communication analytics data.

15. A non-transitory computer-readable medium storing a set of instructions, the set of instructions comprising:
one or more instructions that, when executed by one or more processors of a device, cause the device to:
provide, to a network device, an indication that the device is capable of processing network data analytics function (NWDAF) analytics data associated with a user equipment (UE);
receive, from the network device, the NWDAF analytics data based on the indication;
store the NWDAF analytics data;
receive, from a law enforcement agency (LEA), a lawful interception request for the UE;
receive interception data for the UE based on the lawful interception request;
provide the interception data and the NWDAF analytics data to the LEA based on the lawful interception request; and
delete the interception data and the NWDAF analytics data after providing the interception data and the NWDAF analytics data to the LEA.

16. The non-transitory computer-readable medium of claim 15, wherein the one or more instructions further cause the device to:
determine that the device is capable of processing the NWDAF analytics data; and
generate the indication that the device is capable of processing the NWDAF analytics data based on determining that the device is capable of processing the NWDAF analytics data.

17. The non-transitory computer-readable medium of claim 15, wherein the one or more instructions, that cause the device to receive the NWDAF analytics data based on the indication, cause the device to:
receive the NWDAF analytics data for a configurable time period; and
provide, to the network device, a request to update the configurable time period for NWDAF analytics data.

18. The non-transitory computer-readable medium of claim 15, wherein the one or more instructions further cause the device to:
encrypt the NWDAF analytics data prior to storing the NWDAF analytics data.

19. The non-transitory computer-readable medium of claim 15, wherein the one or more instructions, that cause the device to provide the interception data and the NWDAF analytics data to the LEA, cause the device to:
generate a report based on the interception data;
include the NWDAF analytics data as an attachment to the report; and
provide the report and the attachment to the LEA.

20. The non-transitory computer-readable medium of claim 15, wherein the one or more instructions further cause the device to:
receive, from the LEA, a removal request to remove the UE from lawful interception;
provide, to the network device, a request to unsubscribe from the NWDAF analytics associated with the UE based on the removal request; and
receive, from the network device, a confirmation of unsubscribing from the NWDAF analytics associated with the UE.
